(19) United States
(12) Patent Application Publication
(10) Pub. No.: US 2001/0044693 A1
(43) Pub. Date: Nov. 22, 2001

(54) ROUTE GUIDANCE APPARATUS

(76) Inventors: SHINICHIROU GOTOU, WAKO-SHI (JP); TAKESHI IMAI, WAKO-SHI (JP); MASAYUKI IKEGAMI, WAKO-SHI (JP); HIDESHI SAWADA, WAKO-SHI (JP); TOSHIHIDE YOUFU, WAKO-SHI (JP)

Correspondence Address: ARENT FOX KINTNER PLOTKIN & KAHN, PLLC, 1050 CONNECTICUT AVENUE, NW, SUITE 600, WASHINGTON, DC, 200365339

(21) Appl. No.: 09/124,089

(22) Filed: Jul. 29, 1998

(30) Foreign Application Priority Data
Jul. 31, 1997 (JP) 9-206958

(51) Int. Cl. G01C 21/00; G09B 29/00

(52) U.S. Cl. 701/202; 701/207; 701/213; 455/412

(57) ABSTRACT

The present invention relates to a route guidance apparatus comprises: a mobile computer having a communication means, an input means, an output means, and a position sensor, the mobile computer being carried by a user; a host computer having a communication means and a data storage means; a user computer; and a communication network for establishing communication between the mobile computer, the host computer, and a user computer, wherein the host computer stores information corresponding to a travel route selected by a user in the data storage means, and transmits the information to the mobile computer through the communication network, the mobile computer outputting the travel route through the output means.

### FIELD OF THE INVENTION

The present invention relates to a route guidance apparatus installed in a vehicle such as a car to enable a driver (user) to traverse a selected route and to a navigational planning method for planning a travel route in accordance with a travel purpose or condition.

This application is based on Japanese Patent Application No. Hei 9-206958, the contents of which are incorporated herein by reference.

### BACKGROUND ART

Various types of software applications (computer programs) for displaying an appropriate route (path) in response to a user input of a departure point, a destination, and a departure date if necessary, have been developed with advances in electronics technology in recent years.

These software applications are remarkably developed in the automobile industry, where automobile navigation systems enjoy popularity. These automobile navigation systems have a device such as a radio navigation device and an inertial navigation device for locating a vehicle using a satellite, and an input device such as a VICS (vehicle information and communication system) for periodically inputting traffic information provided from organizations (information regarding construction work, closed routes due to traffic accidents, traffic jams, etc.) to provide comfortable route guidance to avoid traffic delays.

The outlined automobile navigation systems have various additional functions. Japanese Patent Application, Second Publication No. Hei 6-16320 discloses a system which receives information regarding facilities (tourist attractions, stores, etc.), which includes, for example, congestion, charges, prices, scheduled or nonscheduled entertainment, etc., displays this information, and provides instructions to enable a driver to traverse an appropriate travel route when names of the facilities are inputted.

Further, various devices or methods for obtaining information from organizations and for providing the information to a mobile body such as an automobile are disclosed in, for example, Japanese Patent Application, Second Publication No. Sho 55-26519, which discloses an apparatus which looks up the most appropriate route and necessary facility information from a database provided from organizations, stores the extracted information in a data storage medium such as an IC card or a floppy disc (a magnetic or optical disc), reads the information from the data storage medium with a reading device within a vehicle, and displays the information.

Furthermore, an apparatus which receives necessary information such as a map data periodically or at predetermined intervals and records the information on a rewritable data medium, has been developed in Japanese Patent Application, First Publication No. Hei 5-274592 for example.

However, because in the above prior art, the driver in the automobile must operate these apparatuses by himself, travel planning in cooperation with a number of members such as fellow passengers in the automobile is impossible, and a travel plan cannot be confirmed through a displayed map or displayed information. An additional data storage device such as an IC card installed in the mobile body increase costs, and makes the construction more complicated.

### SUMMARY OF THE INVENTION

It is therefore an object of the present invention to provide a route guidance apparatus which can provide travel planning for a number of members based on a wealth of information, can reduce costs, and can make route guidance easier.

In order to accomplish the above object, a route guidance apparatus of the present invention comprises: a mobile computer having a communication means, an input means, an output means, and a position sensor, the mobile computer being carried by a user; a host computer having a communication means and a data storage means; a user computer; and a communication network for establishing communication between the mobile computer, the host computer, and a user computer, wherein the host computer stores information corresponding to a travel route selected by a user in the data storage means, and transmits the information to the mobile computer through the communication network, the mobile computer outputting the travel route through the output means.

According to the invention, a travel route is computed based on information inputted from the input means of the user computer, the route information is stored in the host computer in advance, and the route information is transmitted to the mobile computer through the communication means to allow the output means to provide route guidance instructions, thereby making travel planing by a number of members based on a wealth of information possible, reducing the costs, and making route guidance instructions easier. That is, travel planning using the home personal computer is possible, thereby making travel planning and confirmation with all members before travel possible.

In the route guidance apparatus of the present invention, the host computer may determine the travel route based on planning data inputted by a user through the user computer. The data storage means may store a destination list including information related to a plurality of destinations, the destination list being provided to the user computer through the communication network when the user enters planning data. The communication network may establish communication between the host computer and an information provider for providing information related to travel routes.

According to the invention, a wealth of information is available in the planning process, thus making the travel plan satisfactory, because the travel plan is calculated based on the information from the host computer (installed in a center).

The travel plan calculated by the home computer in advance is stored in the host computer of the center, and is received by the communication means of the mobile computer installed in an automobile, thereby eliminating the an IC card or a reading device.

In another aspect of the present invention, a route guidance apparatus comprises: a mobile computer having a communication means, an input means, an output means, and a position sensor, the mobile computer being carried by a user; a host computer having a communication means, and a data storage means for storing information corresponding a travel route to be tracked; a user computer having an input/output means for entering data by user; and a communication network for establishing communication between the mobile computer, the host computer, said user computer, and an information provider, the information provider providing information related to travel routes, wherein said user computer is connected to the communication network, a travel route being determined based on the data inputted by the input/output means and being stored in the data storage means, information corresponding to the travel route stored in the data storage means being transmitted to the mobile computer, the output means of the mobile computer providing route guidance instructions to enable the user to track the travel route.

In another aspect of the present invention, a method for providing route guidance comprising the steps of: storing information corresponding a travel route selected by a user through a user computer in a data storage means of a host computer; transmitting the information from the host computer to a mobile computer by means of communication network; and outputting the travel route by an output means of a mobile computer carried by a user to provide route guidance instructions.

The method of the present invention may further comprises the step of determining the travel route by the host computer, based on planning data inputted by the user. Further, the method may further comprises the steps of: storing a destination list including information related to a plurality of destinations in the data storage means; and providing the destination list to the user through the communication network when the user enters planning data. Moreover, the method may further comprises the step of establishing communication between the host computer and an information provider for providing information related to travel routes.

In another aspect of the invention, a method for providing route guidance comprises the steps of: transmitting a destination list from a host computer to a user computer, the destination list including information related to a plurality of destinations; displaying the destination list by a display means of the user computer; entering planning data through an input means of the user computer by a user; generating a plurality of travel plans based on the destination list and the planing data; displaying the travel plans on the display means; selecting one of the travel plans by the user through the input means and calculating a travel route based on the selected travel plan; transmitting information corresponding to the travel route to a host computer; storing the information in a storage means of the host computer; and transmitting the information to a mobile computer carried with the user.

In another aspect of the invention, a method for providing route guidance comprising the steps of: entering planning data through an input means of the user computer by a user; transmitting the planning data to a host computer; generating a plurality of travel plans based on the planing data and information provided from information provider; storing information corresponding to the travel plans in a data storage means of the host computer; transmitting the information to a mobile computer carried by a user; selecting one of the travel plans through an input means of the mobile computer by the user; and displaying a travel route corresponding to the selected travel plan on the display means of the mobile computer.

### BRIEF DESCRIPTION OF THE DRAWINGS

FIG. 1 is a block diagram showing a construction of a navigation apparatus (route guidance apparatus) according to the present invention.

FIG. 2 is a flow chart showing a process (planning process) carried out in a first embodiment of the present invention.

FIG. 3 is a flow chart showing a process (operating process) carried out in the first embodiment of the present invention.

FIG. 4 is a flow chart showing a process (planning process) carried out in a second embodiment of the present invention.

FIG. 5 is a flow chart showing a process (operating process) carried out in the second embodiment of the present invention.

### DETAILED DESCRIPTION OF THE PREFERRED EMBODIMENTS

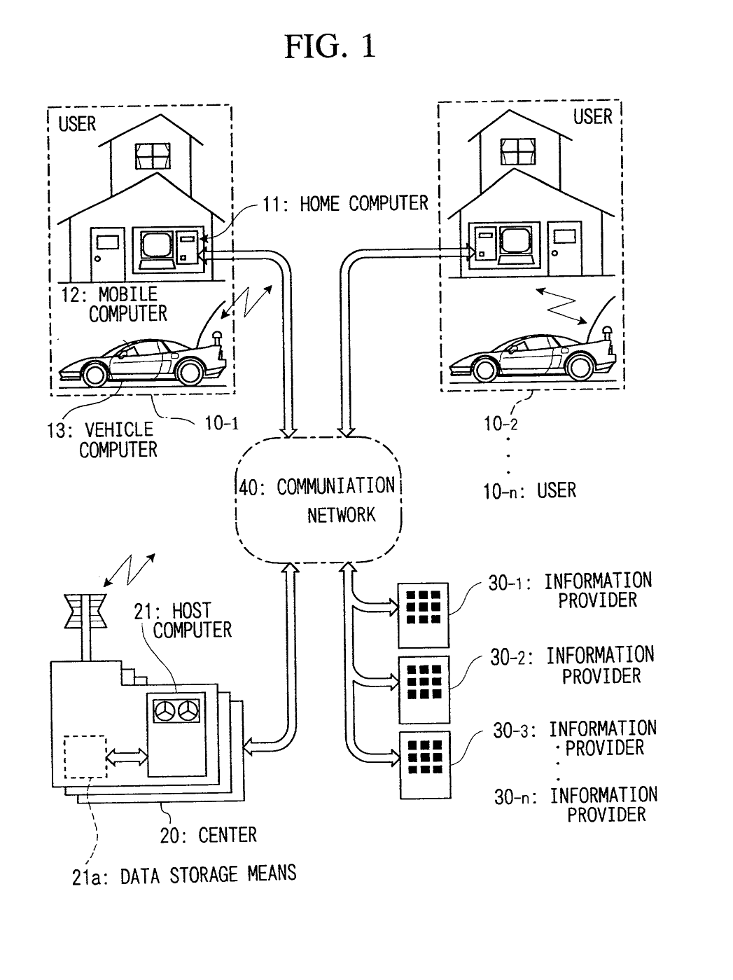

Referring to FIG. 1, the best mode of the navigation apparatus (route guidance apparatus), according to an embodiment of the present invention, will be explained.

In FIG. 1, reference numerals 10-1, 10-2 . . . to 10-n denote users who have home computers (user computers) 11 and mobile computers 12.

The home computer 11 includes a display means such as a CRT (cathode ray tube) or a LCD (liquid crystal display), an output means such as a printer, an input means such as a keyboard and a mouse, and a communication means such as a modem (modulator/demodulator) or a TA (terminal adapter) for transmitting and receiving digital data.

The mobile computer 12 installed in a mobile body 13 such as an automobile has a position sensor, a display means, an input means, a mobile communication means, and a voice informing means (output means). The position sensor locates a geographical position by specifying a longitude, a latitude, and an address by means of a GPS (global positioning system) using a radio wave from a satellite or a gyro using inertia, and has an LCD for displaying information such as a map to graphically inform the located position and to guide the mobile body. The input means is a keyboard for entering and selecting information according to displayed information and circumstances. The mobile communication means transmits and receives the digital data using radio waves such as MCA radio waves, ultrasonic waves, or light. The voice informing means informs a user of various kinds of information by a voice recorded in a semiconductor memory or a synthesized voice, thus providing guidance instructions.

Reference numeral 20 denotes a center, where a host computer 21 is installed with a communication means for communicating with the home computers 11, a communication means for communicating with the mobile computers 11, and a data storage means 21a which includes memory areas for each of the users 10-1 to 10-n.

Reference numerals 30-1, 30-2, . . . to 30-n denote information providers of facilities and organizations, who provide information regarding maps, facility conditions, entertainment, and traffic.

The home computers 11 are connectable to the center 20 and to the information providers by means of a communication network 40 such as public telephone lines and the internet to transmit and receive the digital data.

An ID, what is generally called an identification number, is assigned to each of the users 10-1 to 10-n and is stored together with a personal reference code including a password or a personal code number (hereinafter simply referred to as a password), which only the user knows, in a predetermined memory area of the data storage means 21a.

First Embodiment

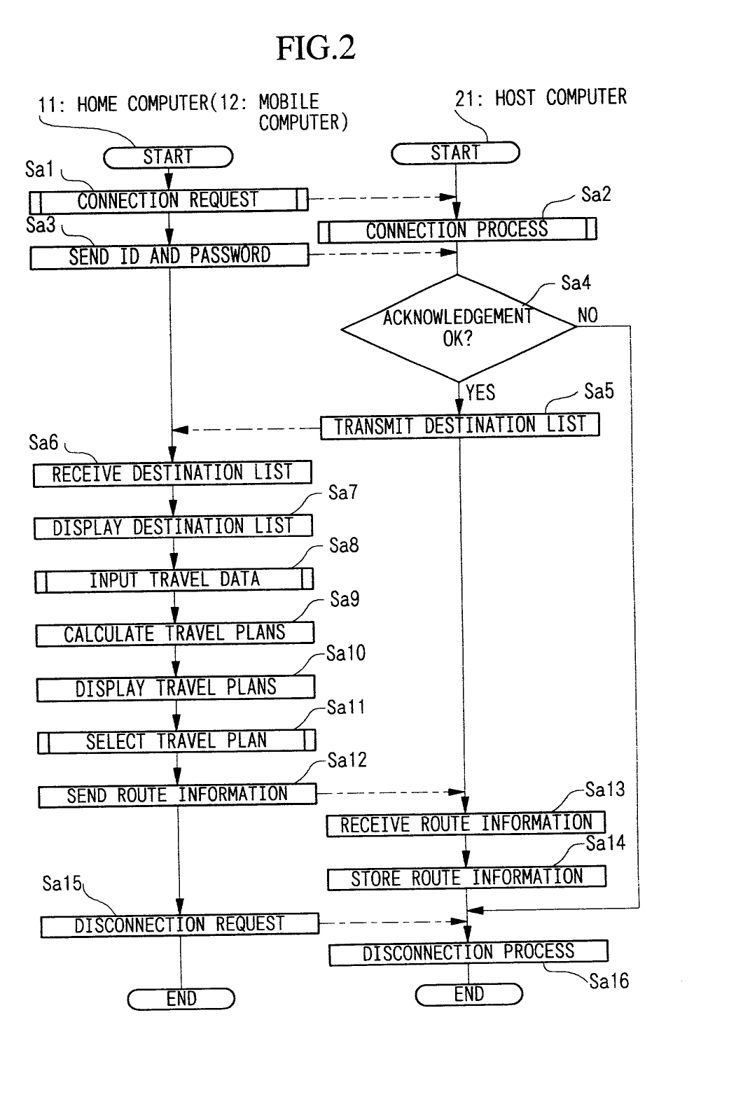

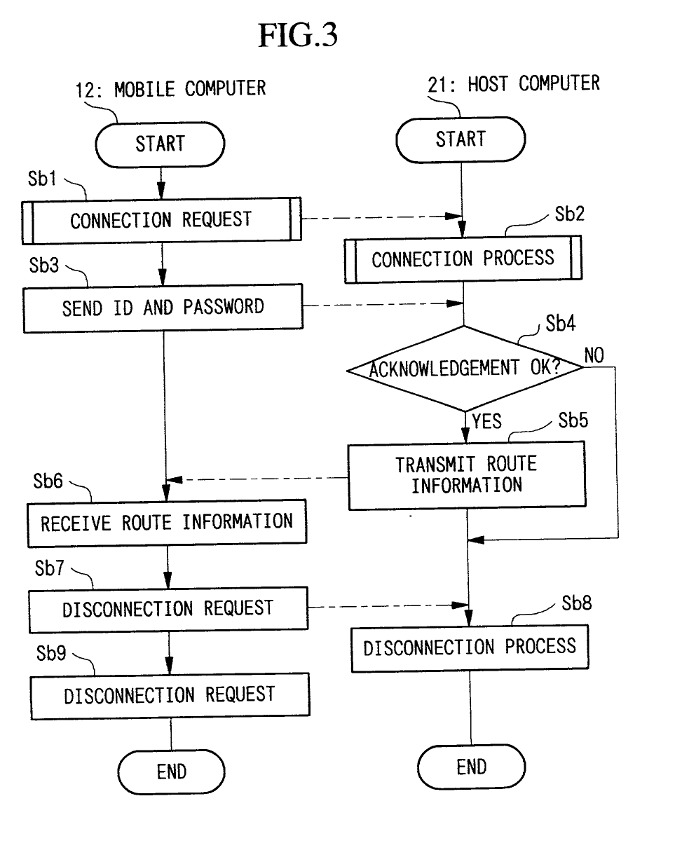

FIGS. 2 and 3 are flowcharts for explaining processes carried out in the first embodiment, and in particular, FIG. 2 shows a planning process where solid lines indicate the flow of the process and alternate long and short dash lines indicate flows of digital data.

The planning processes are carried out under communication between the center 20 and one of the users 10-1 to 10-n. In general, the user 10-m (1≦m≦n) (one of the users) prepares a travel plan in advance by executing the planning process with the home computer 11. The mobile computer 12 may execute the planning process, of which detailed description is omitted.

The process commences at step Sa1, where the user 10-m sends a connection request from the home computer 11 using the communication means via the communication network 40 to prepare transmission and receipt of digital data to and from the host computer 21 of the center 20, that is, to “login” to the network for a situation in which the Internet is used.

The host computer 21 receiving the connection request from the user 10-m executes a connection process to establish communication (at step Sa2). The user 10-m then sends the ID and the password (at step Sa3) and receives an acknowledgement indicating validity of the ID.

The host computer 21 receiving the ID and the password compares the password received with a password recorded in the memory area associated with the ID received (at step Sa4). If the password is invalid, the line is disconnected.

If the ID and the password are acknowledged in the comparison step, the host computer 21 reads a destination list which has been stored in data storage means 21a, and transmits the destination list to the home computer 11 (at step Sa5).

The destination list has been prepared in advance, based on information provided from the information providers 30-1 to 30-n through the communication network 40, and has been stored in the predetermined memory area in the data storage means 21a. The destination list contains information regarding schedules of road works and closed routes for each day and forecasted traffic jams, etc.

The home computer 11 displays the destination list received from the host computer 21 on the display means (at step Sa7), and expects an input of travel data (planning data or conditions) from the user 10-m (at step Sa8). The travel data are to outline a journey, and may contain a destination, a departure time, a distance, a time required, and a budget.

In response to the input of the travel data, the home computer 11 calculates travel plans, based on the destination list and the travel data (at step Sa9). That is, the travel plans are calculated on the information from the destination list regarding the schedules of road works and closed routes, forecasted traffic jams, etc., and on the travel data regarding a destination, a departure time, a distance, a time required, etc.

The home computer 11 displays the computed travel plans on the display means (at step Sa10), and expects a user selection input to select one of the travel plans (at step Sa11).

Upon receipt of a user selection input, the home computer 11 transmits data corresponding to the selected travel plan to the host computer 21 (at step Sa12), which stores the selected route data in the memory area of the data storage means 21 corresponding to the ID of the user 10-m (at step Sa14).

The home computer 11 which has transmitted the data sends a disconnection request to the host computer 21 (at step Sa15), at which point the process in the home computer 11 is completed. Meanwhile, the host computer 21 executes the disconnection process when the host computer 21 receives the disconnection request or when the password is invalid in the comparison of step Sa 4 (at step Sa16).

The planning process is carried out as described above, while an operating process is carried out as shown in the flowchart of FIG. 3, where solid lines indicates the flow of the process and alternate long and short dash lines indicate flows of digital data.

The process commences at step Sb1 where the user 10-m sends a connection request from the mobile computer 12 using the communication means of the mobile computer 12 and a cellular telephone to prepare transmission and receipt of digital data to and from the host computer 21 of the center 20 via the communication network 40, that is, to “login” to the network for a situation in which the Internet is used.

The communication network 40 may be a communication network for mobile bodies using radio waves via the center 20 as a station or a control station for controlling a number of stations, where the connection to the line means to “login” to the network.

Upon receipt of the connection request from the user 10-m, the host computer 21 of the center 20 executes a line connection process, thus establishing communication (at step Sb2). The user 10-m then transmits the ID and the password to the host computer 21 (at step Sb3), and receives an acknowledgement indicating validity of the ID.

The host computer 21 receiving the ID and the password compares the password received to the password recorded in the memory area (not shown) associated with the ID received (at step Sb4). If the password is invalid, the line is disconnected.

After the acknowledgement of the ID and the password of the user 10-m, the host computer 21 transmits the route data stored in the memory area of the data storage means 21 corresponding to the ID of the user 10-m, to the mobile computer 12 (at step Sb5).

The mobile computer 12 receives the route data from the host computer 21 (at step Sb6), and sends a disconnection request to the host computer 21 (at step Sb7). Meanwhile, the host computer 21 executes a disconnection process when the host computer 21 receives the disconnection request or when the password is invalid in the comparison of step Sb4 (at step Sb8).

While transmitting the disconnection request, the mobile computer 12 displays a map indicating the route and the destination point on the display means, and further outputs voice information to provide route guidance instructions for the user 10-m (at step Sb9).

In the route guidance apparatus incorporating a first embodiment of the present invention, a travel route is computed by the planning process in advance and the route data are stored in the host computer through the network. The route data are read through the network, thus allowing the mobile computer to provide route guidance instructions in the operating process.

The home computer may receive various kinds of information directly from the information providers 30-1 to 30-n, and may generate a destination list. The host computer may specify facilities in the travel plan from the route data, may make reservations, and may transmit charge information with the route data to the data storage means. Further, charges for the facilities may be partially or fully paid with the reservations in the process, and the center may later collect the charge from the user.

Second Embodiment

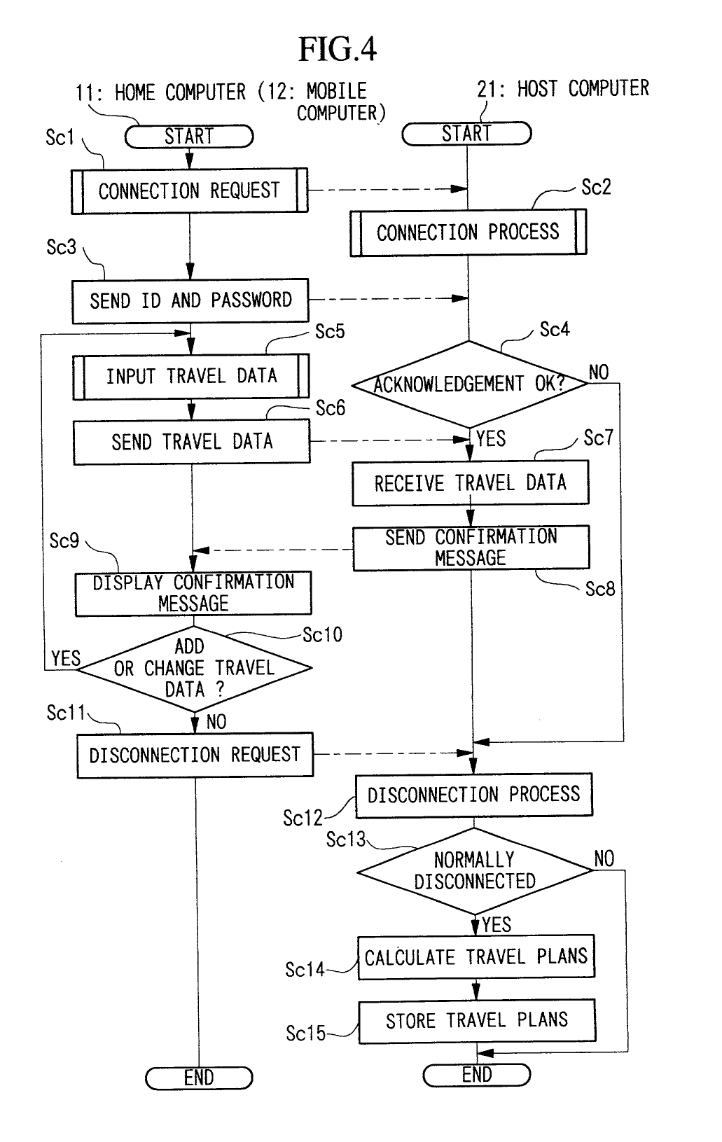

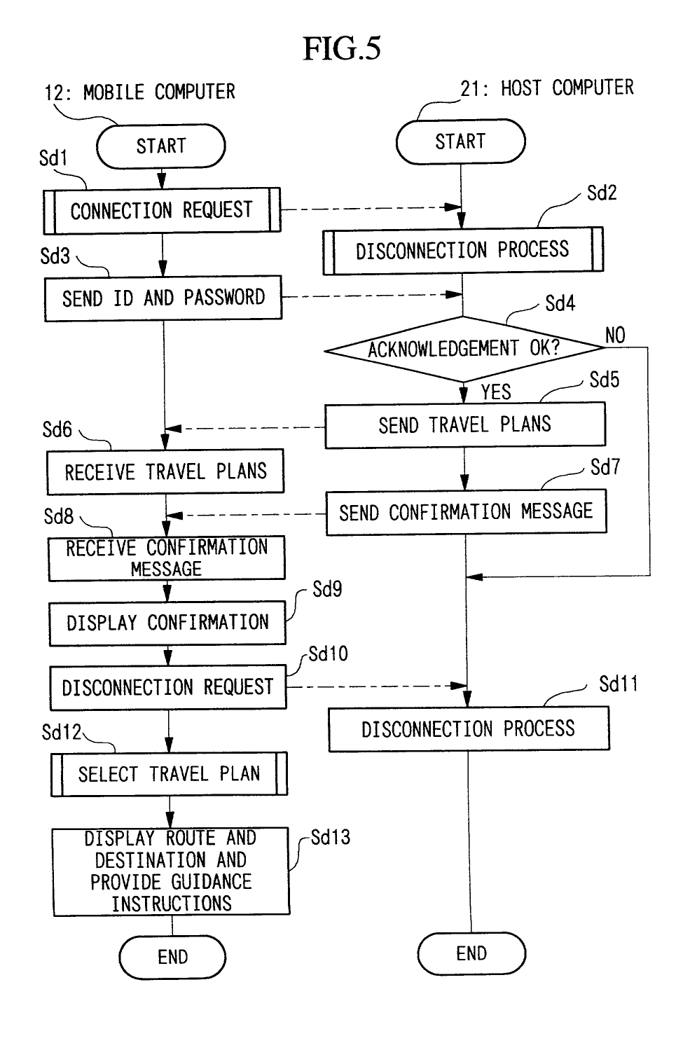

FIGS. 4 and 5 are flowcharts for explaining processes carried out in the second embodiment, and in particular, FIG. 4 shows a planning process where solid lines indicate the flow of the process and alternate long and short dash lines indicate flows of digital data.

The planning processes are carried out under communication between the center 20 and one of the users 10-1 to 10-n. In general, the user 10-m (1≦m≦n) prepares a travel plan in advance by executing the planning process with the home computer 11. The mobile computer 12 may execute the planning process, of which detailed description is omitted.

The process commences at step Sc1, where the user 10-m sends a connection request from the home computer 11 using the communication means via the communication network 40 to prepare transmission and receipt of digital data to and from the host computer 21 of the center 20, that is, to “login” to the network for a situation in which the Internet is used.

The host computer 21 receiving the connection request from the user 10-m executes a connection process to establish communication (at step Sc2). The user 10-m then sends the ID and the password (at step Sc3) and receives an acknowledgement indicating validity of the ID.

The host computer 21 receiving the ID and the password compares the password received with a password recorded in the memory area associated with the ID received (at step Sc4). If the password is invalid, the line is disconnected.

While the host computer performs the comparison process, the user 10-m inputs travel data (conditions) to the home computer 11 (at step Sc5). The travel data are to outline a journey, and may contain a destination, a departure time, a distance, a time required, and a budget. After the travel data are inputted and the ID is verified, the home computer 11 transmits the inputted travel data to the host computer 21 (at step Sc6).

The host computer 21 receives the travel data (at step Sc7), and transmits a confirmation message to the home computer 11 to which the corresponding ID is assigned (at step Sc8). The confirmation message contains a command to direct the display means (not shown) of the home computer 11 to re-display the travel data and to display a prompt for inputs to add or change the travel data.

The home computer 11 displays the confirmation message received (at step Sc9), and expects a user input to add or to change the travel data (at step Sc10). If there is an addition or change, the process returns to step Sc6.

If there is no addition or change in the travel data in step Sc10, the home computer 11 transmits a disconnection request to the host computer 21 (in step Sc11), at which point the process is completed. Meanwhile, the host computer 21 executes a disconnection process when the host computer 21 receives the disconnection request or when the password is invalid in the comparison of step Sc4 (at step Sc12).

The host computer determines that the disconnection is normally carried out after the travel data is normally received (at step Sc13), and calculates a plurality of travel plans which contain travel routes, destination facilities, passing points, and arrival times, based on the travel data (at step Sc14). That is, the travel plans are calculated based on the information from the information providers 30-1 to 30-n regarding the schedules of road works and closed routes, forecasted traffic jams, etc., and on the travel data regarding a destination, a departure time, a distance, a time required, etc.

The host computer 21 stores the travel plans calculated in step Sc14 into a memory area of the data storage means where the corresponding ID has been assigned (at step Sc15), at which point the process is completed.

The planning process is carried out as described above, while an operating process is carried out as shown in the flowchart of FIG. 5, where solid lines indicate the flow of the process and alternate long and short dash lines indicate flows of digital data.

The operating process is carried out under communication between the center 20 and one of the users 10-m. Route instructions are provided to the user 10-m through the mobile computer 12 installed within the mobile body 13, according to one of the travel plans which are calculated in advance based on the travel data inputted into the host computer 21.

The process commences at step Sd1 where the user 10-m sends a connection request from the mobile computer 12 using the communication means of the mobile computer 12 and a cellular telephone to prepare transmission and receipt of digital data to and from the host computer 21 of the center 20 via the communication network 40, that is, to “login” to the network for a situation in which the Internet is used.

The communication network 40 may be a communication network for mobile bodies using radio waves via the center 20 as a station or a control station for controlling a number of stations, where the connection to the line means to “login” to the network.

Upon receipt of the connection request from the user 10-m, the host computer 21 of the center 20 executes a line connection process, thus establishing communication (at step Sd2). The user 10-m then transmits the ID and the password to the host computer 21 (at step Sd3), and receives an acknowledgement indicating validity of the ID.

The host computer 21 receiving the ID and the password compares the password received to the password recorded in the memory area (not shown) associated with the ID received (at step Sd4). If the password is invalid, the line is disconnected.

After the acknowledgement of the ID and the password of the user 10-m, the host computer 21 transmits a plurality of travel plans stored in the memory area of the data storage means 21 corresponding to the ID of the user 10-m to the mobile computer 12 (at step Sd5).

After the mobile computer 12 receives the plurality of travel plans (at step Sd6), the host computer 21 transmits a confirmation message to the mobile computer (at step Sd7). The confirmation message contains elapsed times and charges (telephone charges) for the communication network (predetermined network) 40, and charges when the user 10-m uses fee-charging services.

The mobile computer 12 receives the confirmation message from the host computer 21 (at step Sd8), and displays the outlines of the travel plans together with the confirmation message on the display means (not shown) (at step Sd9).

The mobile computer 12 sends a disconnection request to the host computer 21 (at step Sd1O). Meanwhile, the host computer 21 executes a disconnection process when the host computer 21 receives the disconnection request or when the password is invalid in the comparison of step Sd4 (at step Sd11).

The mobile computer 12 sending the disconnection request expects a user selection input to select one of the travel plans from the user 10-m (at step Sd12). After selection of one of the travel plans, the mobile computer 12 displays a map image indicating the travel route and the destination point according to the selected travel plan, and further provides voice instructions to the user 10-m (at step Sd13).

In the route guidance apparatus incorporating the second embodiment of the present invention, a plurality of travel plans are computed by the planning process in advance and the plans are stored in the host computer. A plurality of the travel plans are read through the network by the mobile computer to allow the user to select one of the travel plans, thus allowing the mobile computer to provide route guidance instructions in the operating process.

Although in the above operating process one of the travel plans is selected through the mobile computer, reservations for facilities to be used in a journey may be possible when the user may make a selection input to the host computer in advance, and data corresponding to the selected plan may be transmitted to the mobile computer. Further, charges for the facilities may be partially or fully paid with the reservations in the process, and the center may later collect the charge from the user.

The computer programs for carrying out the processes in the home computer, the mobile computer, and the host computer may be recorded in semiconductor memories or hard-disk drives (fixed discs, or magnetic recording devices) installed in the computers, or in magnetic or optical recording media such as floppy discs, metal tape, or CD-ROMs (Compact Disc-Read Only Memories).

Although in the embodiments the mobile computer is installed in the mobile body such as an automobile, a mobile computer and a cellular telephone may be combined and a user traveling on foot or on a bicycle may carry them.

This invention may be embodied in other forms or carried out in other ways without departing from the spirit thereof. The present embodiments are therefore to be considered in all respects illustrative and not limiting, the scope of the invention being indicated by the appended claims, and all modifications falling within the meaning and range of equivalency are intended to be embraced therein.

What is claimed is:

1. A route guidance apparatus comprising:
a mobile computer having a communication means, an input means, an output means, and a position sensor, said mobile computer being carried by a user;
a host computer having a communication means and a data storage means;
a user computer; and
a communication network for establishing communication between said mobile computer, said host computer, and said user computer,
wherein said host computer stores information corresponding to a travel route selected by a user in said data storage means, and transmits said information to said mobile computer through said communication network, said mobile computer outputting said travel route through said output means.

2. A route guidance apparatus according to claim 1, wherein said host computer determines said travel route based on planning data inputted by a user through said user computer.

3. A route guidance apparatus according to claim 1, wherein said data storage means stores a destination list including information related to a plurality of destinations, said destination list being provided to said user computer through said communication network when said user enters planning data.

4. A route guidance apparatus according to claim 1, wherein said communication network establishes communication between said host computer and an information provider for providing information related to travel routes.

5. A route guidance apparatus comprising:
a mobile computer having a communication means, an input means, an output means, and a position sensor, said mobile computer being carried by a user;
a host computer having a communication means, and a data storage means for storing information corresponding to a travel route to be traveled;
a user computer having an input/output means for entering data by a user; and
a communication network for establishing communication between said mobile computer, said host computer, said user computer, and an information provider, said information provider providing information related to travel routes,
wherein said user computer is connected to said communication network, a travel route being determined based on data inputted by said input/output means and being stored in said data storage means, information corresponding to said travel route stored in said data storage means being transmitted to said mobile computer, said output means of said mobile computer providing route guidance instructions to enable said user to track said travel route.

6. A method for providing route guidance comprising the steps of:
storing information corresponding a travel route selected by a user through a user computer in a data storage means of a host computer;
transmitting said information from said host computer to a mobile computer by means of communication network; and
outputting said travel route by an output means of a mobile computer carried by a user to provide route guidance instructions.

7. A method according to claim 6 further comprising the step of determining said travel route by said host computer, based on planning data inputted by said user.

8. A method according to claim 6 further comprising the steps of:
storing a destination list including information related to a plurality of destinations in said data storage means; and
providing said destination list to said user through said communication network when said user enters planning data.

9. A method according to claim 6 further comprising the step of establishing communication between said host computer and an information provider for providing information related to travel routes.

10. A method for providing route guidance comprising the steps of:
transmitting a destination list from a host computer to a user computer, said destination list including information related to a plurality of destinations;
displaying said destination list by a display means of said user computer;
entering planning data through an input means of said user computer by a user;
generating a plurality of travel plans based on the destination list and the planing data;
displaying said travel plans on said display means;
selecting one of said travel plans by said user through said input means and calculating a travel route based on the selected travel plan;
transmitting information corresponding to said travel route to a host computer;
storing said information into a storage means of said host computer; and
transmitting said information to a mobile computer carried with a user.

11. A method for providing route guidance comprising the steps of:
entering planning data through an input means of a user computer by a user;
transmitting the planning data to a host computer;
generating a plurality of travel plans based on the planing data and information provided from information provider:
storing information corresponding to the travel plans in a data storage means of said host computer;
transmitting said information to a mobile computer carried by a user;
selecting one of the travel plans through an input means of said mobile computer by said user;
displaying a travel route corresponding to the selected travel plan on said display means of said mobile computer.
